(19) United States
(12) Patent Application Publication
(10) Pub. No.: US 2017/0351765 A1
(43) Pub. Date: Dec. 7, 2017

(54) User Education Using Personalized and Contextual Cues Based on User's Past Action

(71) Applicant: Microsoft Technology Licensing, LLC, Redmond, WA (US)

(72) Inventors: Mouni Reddy, Seattle, WA (US); Nishchay Kumar, Delhi (IN); Vipindeep Vangala, Telangana (IN)

(21) Appl. No.: 15/247,738

(22) Filed: Aug. 25, 2016

(30) Foreign Application Priority Data
Jun. 3, 2016 (IN) 201641019210

(51) Int. Cl. G06F 17/30; G06N 5/04

(52) U.S. Cl. CPC G06F 17/30867; G06N 5/04; G06F 17/30769

(57) ABSTRACT

Providing cues from a personal digital assistant to a user. A method includes identifying at least one of a contextual condition or piece of personal information applying to a user. The method further includes, based on the at least one of a contextual condition or piece of personal information, identifying a cue indicating a computing action that the user can request be performed by the computing device. The method further includes providing to the user, at a computing device, the cue.

### CROSS-REFERENCE TO RELATED APPLICATIONS

This application claims the benefit of and priority to Indian Provisional Application 201641019210 filed Jun. 3, 2016 entitled “User Education Using Personalized and Contextual Cues Based on User's Past Action” which application is expressly incorporated herein by reference in its entirety.

### BACKGROUND

### Background and Relevant Art

Computers and computing systems have affected nearly every aspect of modern living. Computers are generally involved in work, recreation, healthcare, transportation, entertainment, household management, etc.

Many computers are intended to be used by direct user interaction with the computer. As such, computers have input hardware and software user interfaces to facilitate user interaction. For example, a modern general purpose computer may include a keyboard, mouse, touchpad, camera, etc. for allowing a user to input data into the computer. In addition, various software user interfaces may be available.

Additionally, many modern computer systems now use a personal digital assistant such as Cortana available from Microsoft Corporation of Redmond, Wash. or Siri available from Apple Corporation of Cupertino, Calif. These digital assistants assist users in directing various computing tasks such as performing Internet searches, scheduling appointments, making phone calls, checking traffic, identifying driving routes, etc. Often, the user will simply speak into the digital device requesting that a computing task be performed. Voice recognition functionality integrated into the computing device can be used to identify a desired computing action and to work with the computing device to perform the desired computing action.

One difficulty in encouraging users to use personal digital assistants relates to the unfamiliarity of the users with the personal digital assistants in the functionality that the personal digital assistants are capable of. While some systems have attempted to remedy this by providing hints and tips (i.e., cues), the user may be interested in a hint or tip, but may not be particularly interested in the hint or tip at the time the hint or tip is provided. Thus, while a user may be generally interested in using a personal digital assistant, the learning curve can be steep which results in lower adoption rates for use of personal digital assistants.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a computing environment. The method includes acts for providing cues from a personal digital assistant to a user. The method includes identifying at least one of a contextual condition or piece of personal information applying to a user. The method further includes, based on the at least one of a contextual condition or piece of personal information, identifying a cue indicating a computing action that the user can request be performed by the computing device. The method further includes providing to the user, at a computing device, the cue.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing device and a server implementing a personal digital assistant;

FIG. 2A illustrates an example user interface showing cues that could be provided to a user;

FIG. 2B illustrates another example user interface showing cues that could be provided to a user; and

FIG. 3 illustrates a method of providing cues from a personal digital assistant to a user.

### DETAILED DESCRIPTION

Embodiments illustrated herein can provide user education regarding personal digital assistants that is personalized and textually relevant. In this way, the user is likely to use a cue when the cue is provided to the user. By personalizing education and cues to the particular user, it becomes more likely that the user will adopt the education and cues and thus more likely that the user would use the personal digital assistant.

Several examples of cues that can be surfaced to users on different surfaces are now illustrated. These examples illustrate graphically how the examples described below might be implemented.

Many of the following examples will be illustrated in the context of Cortana, which is the personal digital assistant available from Microsoft Corporation of Redmond, Wash. However, it should be appreciated that the concepts and principles can be applied to other digital assistants.

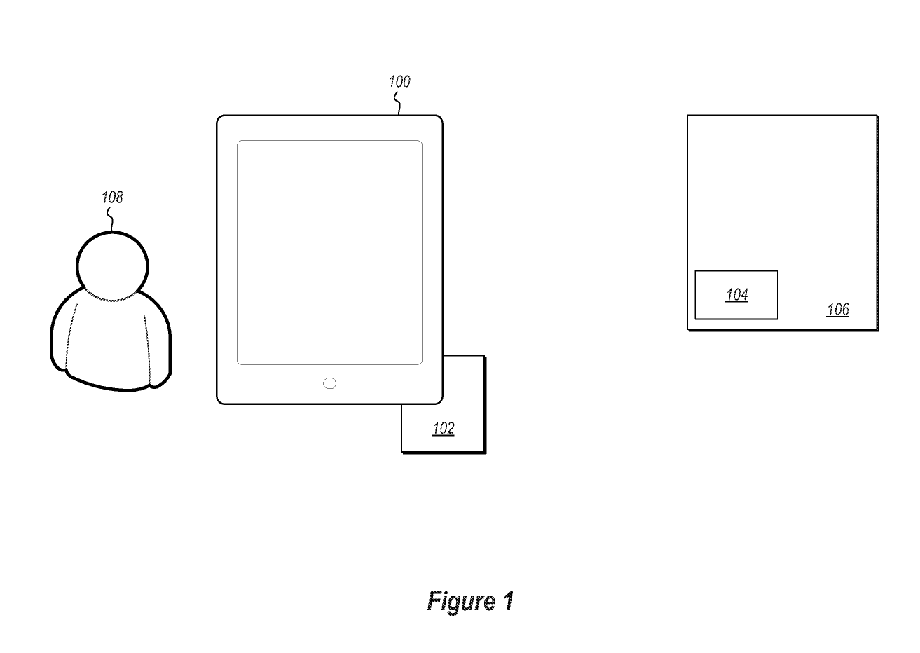

Referring now to FIG. 1, a device 100 is illustrated. The device may be, for example, a smart cellular telephone, a tablet device, a laptop device, a desktop device or other device. The device 100 has implemented thereon a personal digital assistant.

The personal digital assistant has a client side piece 102 implemented at the device 100 that can connect to a server side piece 104 implemented at a server 106. The user 108 provides input at the client side piece 102 (typically by speaking or typing into the digital device 100 hosting the client side piece 102). The user input is provided to the server side piece 104 which then performs voice recognition and/or other intent deduction to deduce a user's intent with respect to a computing function, and causes a user desired function to be performed. Thus, a personal digital assistant typically includes a client side piece 102 and a server side piece 104.

A personal digital assistant may support hundreds of features which may range from the ability to answer generic questions like “Who is the US President” and “convert pounds to dollars” to personalized questions like “Show me my cable bills” and “when will my flight reach its destination”. The features range from reactive questions, proactive recommendations, user configuration etc., to more complex scenarios like trip planning.

As noted, it may be difficult for users to discover these features. It is not that the user is not interested in the unused feature, but the user is not aware of the feature. One way many products solve this problem is to create a help page, where features are listed and/or explained. However, the user typically has a short memory with respect to provided cues and/or they may not care to read and understand 100's of features listed in one location—remember them, and use them later.

Embodiments herein can remedy this by providing a framework, that understands the user's current context, cross device features, and personal preferences that are based on earlier usage and personal data. Using this, embodiments implement a framework that can surface “the right personal digital assistant feature, for the right user, at the right time, and right place”—and educate the user on how to use it, such as for example, providing cues. Thus, cues are provided that are personalized and/or contextually relevant. For example: when the user is travelling to Seattle—embodiments detect that the user is travelling, and use the user's past data to infer that user is from India. So for this travelling user embodiments show personal digital assistant cues to the user that are contextually relevant to the user and that the user can use in a short time frame from when the cue is provided, such as “convert $ to INR”. Note that this feature and cue is personalized (INR is based on user's currency) and context ($ based on current location and detecting travel intent).

Embodiments can implement a paradigm of surfacing cues including contextual and personalized features (along with how to use them) of a personal assistant, based on the current context and the user's past behavior (proactively and reactively). Thus, embodiments transform normal personal digital assistant features into context rich formats. This combined with the user's context understanding (location, time, place, event, activity, etc.) and personal information, can be used to surface the right personal digital assistant feature to the right user at right time. This not only helps in discovering available features generally and at a time when they are likely to be used and thus remembered, but also drives adaption of the products like personal digital assistants. The framework can be implemented on any one of a number of products and environments and can even be used for roaming across canvases (e.g., mobile canvases, desktop canvases, browser canvases, etc.).

Thus, embodiments may implement a framework that provides education (such as providing cues) relevant to the right features, to the right user, at the right time to help a user to complete a computing task which the user is likely to be interested in completing. This can be done without the user having to spend a lot of time in learning about them and memorizing them. Additionally, by providing such education to the user, this can actually create more efficient devices. In particular, user interactions are particularly resources intensive on devices. User interaction represents a bottle neck as well as resource intensive computing in the form of timers, interrupts, input device input processing, etc. If the user is prompted with an efficient way to cause a computing task to be performed, then the user will have less overall interaction with the computing device making the computing device more efficient due to the reduced need for user interaction.

The contextual and personalized help framework detects the users' perceived needs in a current context, and provides the personalized cues on what features the user is perceived to need at the current time and how to use them. This helps the user be more productive through using the personal assistant, and helps increase the engagement of personal digital assistant services.

Thus, embodiments may implement a framework to understand the context of the user (e.g., location, time, activity etc.) and provide relevant features of interest in the given context. This includes commands, features, and configurations that are used to have a user's desired computing task performed.

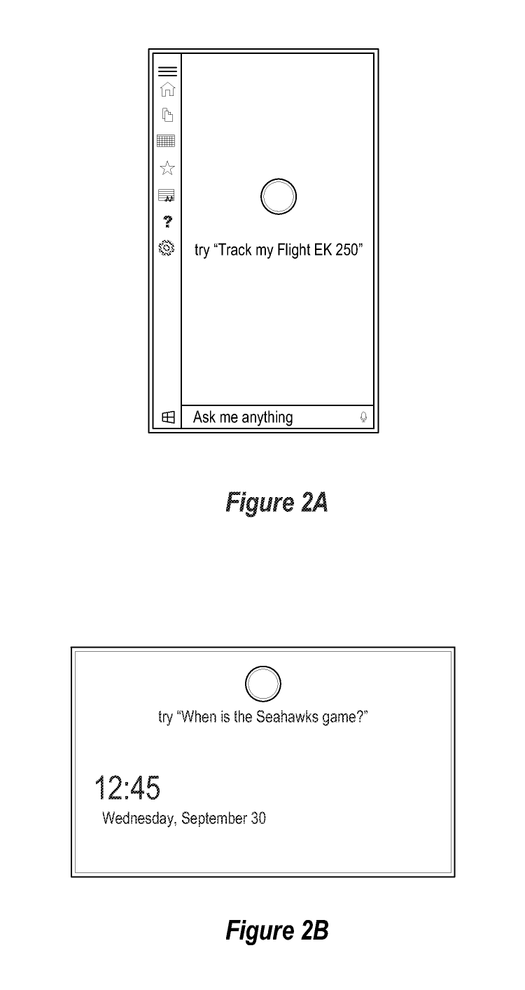

Embodiments may implement a framework that provides the content in a personalized format. For example, embodiments may provide cues directing the user to input a command into the personal digital assistant such as “track my flight EK250”, where content of the command “EK250” is personalized based on what the computing system already knows about the user, such as through inferences. For example, the computing system may have access to a user's email and know that a purchase confirmation has been received for flight EK250. As illustrated at FIG. 2A, the personal digital assistant can provide a prompt on a device screen for the device 100 that says “try ‘track my flight EK250’” prompting the user to speak this command into the personal digital assistant client at the computing system.

Embodiments may implement a framework that surfaces contextual and personalized features as cues proactively on any surface. Such surfaces may include an active canvas, a task bar, a notification, an email application, etc.

Embodiments may implement a framework that extracts metadata for features and corresponding cues so as to provide personalized and contextual ranking.

Embodiments may implement an algorithm that helps rank cues for features based on a current task at hand, in a given context.

Embodiments may implement functionality to understand and reason on user's past data (such as browsing history, personal digital assistant engagement, app usage, etc.) to identify what kind of features the users need, and what is already known. For example, if the user has already used “convert $ to INR”, embodiments will show a more advanced feature that the user may not now be aware of yet like “Convert $320 to INR” etc.

Embodiments may implement a framework to intelligently rank based on the features that have been shown so far by the service. The framework automatically learns what is appealing to user and what is not—and adapts the new features and cues that will be shown going forward.

The following now illustrates various contextual examples and personalization examples that may result in embodiments providing cues.

Embodiments may provide cues when it is determined that a user is traveling.

Embodiments may provide cues when it is determined that a user is at a given location, or that are relevant to a given contextually relevant location. Location may be determined based on location hardware, such as a GPS, cellular radio, Wi-Fi radio, etc. included in the computing device 100. Alternatively or additionally, location may be determined based on network characteristics (such as IP addresses) or other information.

Embodiments may provide cues that are contextually relevant o an event that occurs. Thus, for example, when an incoming phone call is detected or a message is received, cues identifying functionality relevant to phone calls or messages may be displayed visually.

The following illustrates some cues and when the cues might be displayed to a user based on context and/or personalization.

For example, as illustrated in FIG. 2B, an embodiment may display the cue “try ‘When is the <favorite team> game?’”

This cue may be based on knowledge about the user's favorite team. This information could be obtained from user settings. Alternatively or additionally, this may be determined by identifying that the user has attended a number of the favorite teams's games. This can be determined based on collected location information about the user's device 100 and information that can be obtained about where and when games are played.

Contextually, the most likely time a user will make sports query is close to the game day (and potentially game time) of their favorite team and sport. As such, triggers for the Sports cues for a user could be: {next_game_of favorite_team}<48 hrs==true?

This cue could be applicable for all devices and/or surfaces used by a user.

Display Text=“When is the next {favorite_team} game?”

The Tip “try ‘When is the Seahawks game’” would trigger for a Seahawks fan and show up for some time on all their surfaces during regular season.

Another example includes the cue: “try ‘Play songs by <recent artist>’”

This cue may be displayed based on personal information known about what songs, artists, albums, etc, that a user has listened to. Contextually, the tip may be displayed at times and/or places where playing music might be desirable. For example, the personal digital assistant may know that the user listens to music during their commute. When the personal digital assistant determines that the user may be about to begin a commute, the personal digital assistant can provide the cue.

Certain cues are only relevant or more relevant in certain time windows or based on a client action. For example, 24 hours or less before a flight, a cue including “try ‘When is my flight?’” may be displayed. Alternatively or additionally, when music is playing the cue “try ‘Pause music’” may be displayed. Alternatively or additionally, when a user is at home in the morning the cue “try ‘What's the traffic like to work?’” may be displayed.

Some embodiments may provide roll-up cues. Roll-up cues are cues that show when the user completes a certain task or gets an answer. A roll up cue may be exactly the same as a global cue, that is, a cue that can be provided in any context, except for when and where it shows up. Hence, in some embodiments, for operational efficiency, roll-up cues are not authored separately but rather linked to existing global tips, but with limits on when, how and where the cues can be displayed. Types of roll up cues may include efficiency cues and/or other functionality. Roll up tips may have properties such as:

Associated Global Tip ID for each intent

Impressions/Dwell time

In some embodiments, roll up cues do not have special triggering logic.

Embodiments may be implemented where all global cue features (except triggering and ranking) apply to roll up cues.

In-flow cues may be provided in some embodiments, and guide the users during a multi-turn flow. These cues prompt the users with cues for the user when the personal digital assistant asks the user for more information regarding their task. The following illustrates an example:

User: “Create an appointment”

The personal digital assistant: “When is your appointment (Tip: 2 PM on Friday)?”

This cue lets the user know that they can naturally say the time and day.

Some embodiments may determine device context based on the actions taken on apps on the device 100. This could apply to both 1^{st} party (i.e., the device maker, operating system provider, etc.) and 3^{rd} party apps.

A device operating system can gather signals based on user initiated. actions such as website visits and actions in first party apps. As noted, 3^{rd} party apps can also plug into this framework. For example, if the user manually opens the “Trending section on Twitter”, the Twitter app can choose to show the cue “try ‘Go to what's trending on Twitter’” in the taskbar to tell the user they can get to trending topics faster.

Embodiments may be implemented where apps can integrate with the personal digital assistant. For example, in Windows, available from Microsoft Corporation of Redmond, Wash., there are 100s of Windows 10 apps that integrate with the personal digital assistant (in this case, Cortana) with the voice command definition (VCD) framework. Embodiments can promote VCD speech cues to drive traffic to the apps. The ranking for content from apps, in some embodiments, is based on date of install, user's frequency of usage, or other factors.

Certain parameters may be specified for cues. The following illustrate some example global values that may be maintained per cue:

CUE ID: A single ID associated with each cue. This is a unique identifier for the cue across the entire system.

Time to live (TTL): This is used for both ranking and calculating the life time of the cue.

Context Trigger: The time or event which makes the cue valid. Sonic triggers may be time based triggers. In other embodiments, client signal based triggers may be used.

URI

Some embodiments may implement parameters stored as local values. The following illustrates some examples of local values that may be maintained for cues.

Display text: Each surface can show the preferred display text. Speech cues can say “try ‘Get me directions to the Microsoft Store’” and the personal digital assistant Home can say “try ‘Get directions to the Microsoft Store’”.

Penalty: Showing the cue on a surface accrues a penalty to the TTL. It varies per surface.

Rotate time; Switch the text after ‘x’ seconds to the next cue in the system. Applies to Lock, Home, Task bar tease, etc.

Some embodiments may limit the presentation of cues based on an inference that the user knows how to use the functionality associated with the cue. For example, if a user already has past knowledge of a domain and has recently (in, for example, the past 90 days) used that answer, the personal digital assistant will not show the cues. Thus for example, the personal digital assistant will show the “set an alarm” cue only if the user has not set alarms with the personal digital assistant in the recent past as determined by some predetermined time.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

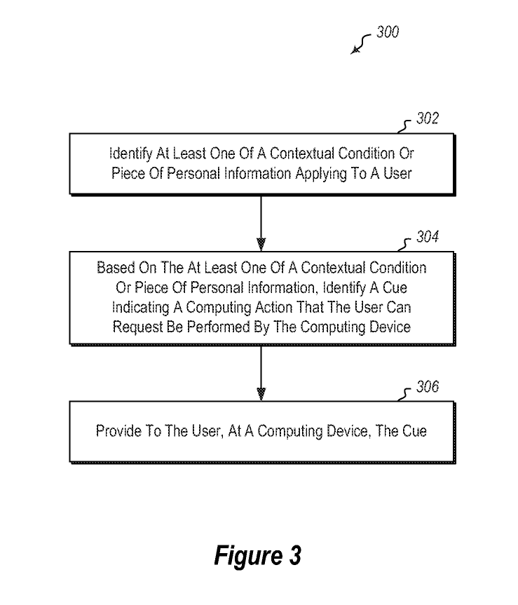

Referring now to FIG. 3, a method 300 is illustrated. The method 300 may be practiced in a computing environment. The method 300 includes acts for providing cues from a personal digital assistant to a user. The method 300 includes identifying at least one of a contextual condition or piece of personal information applying to a user (act 302). For example, the at least one contextual condition may include a time of day. Alternatively or additionally, the at least one contextual condition may include a location. Alternatively or additionally, the at least one contextual condition may include a location of the computing device. Alternatively or additionally, the at least one contextual condition may include a condition suggesting that the user is traveling. Alternatively or additionally, the at least one piece of personal information applying to a user is based on inferences. Alternatively or additionally, the at least one piece of personal information applying to a user comprises one or more of browsing history, personal digital assistant engagement, app usage, etc.

The method 300 further includes, based on the at least one of a contextual condition or piece of personal information, identifying a cue indicating a computing action that the user can request be performed by the computing device (act 304).

The method 300 further includes, providing to the user, at a computing device, the cue (act 306).

Further, embodiments may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising:
one or more processors; and
one or more computer-readable media having stored thereon instructions that are executable by the one or more processors to configure the computer system to provide cues from a personal digital assistant to a user, including instructions that are executable to configure the computer system to perform at least the following:
identify at least one of a contextual condition or piece of personal information applying to a user;
based on the at least one of a contextual condition or piece of personal information, identify a cue indicating a computing action that the user can request be performed by a computing device; and
provide to the user, at the computing device, the cue.

2. The system of claim 1, wherein the at least one contextual condition comprises a time of day.

3. The system of claim 1, wherein the at east one contextual condition comprises a location.

4. The system of claim 1, wherein the at least one contextual condition comprises a location of the computing device.

5. The system of claim 1, wherein the at least one contextual condition comprises a condition suggesting that the user is traveling.

6. The system of claim 1, wherein the at least one piece of personal information applying to a user is based on inferences.

7. The system of claim 1, wherein the at least one piece of personal information applying to a user comprises one or more of browsing history, personal digital assistant engagement, or app usage.

8. In a computing environment, a method of providing cues from a personal digital assistant to a user, the method comprising:
identifying at least one of a contextual condition or piece of personal information applying to a user;
based on the at least one of a contextual condition or piece of personal information, identifying a cue indicating a computing action that the user can request be performed by a computing device; and
providing to the user, at the computing device, the cue.

9. The method of claim 8, wherein the at least one contextual condition comprises a time of day.

10. The method of claim 8, wherein the at least one contextual condition comprises a location.

11. The method of claim 8, wherein the at least one contextual condition comprises a location of the computing device.

12. The method of claim 8, wherein the at least one contextual condition comprises a condition suggesting that the user is traveling.

13. The method of claim 8, wherein the at least one piece of personal information applying to a user is based on inferences.

14. The method of claim 8, wherein the at least one piece of personal information applying to a user comprises one or more of browsing history, personal digital assistant engagement, or app usage.

15. A computing system comprising:
a computing device, wherein the computing device is coupled to a personal digital assistant, wherein the personal digital assistant is configured to:
identify at least one of a contextual condition or piece of personal information applying to a user;
based on the at least one of a contextual condition or piece of personal information, identify a cue indicating a computing action that the user can request be performed by the computing device; and
provide to the user, at the computing device, the cue.

16. The computing system of claim 15, wherein the computing device comprises a client side piece of the personal digital assistant configured to couple to a server side piece of the personal digital assistant at a server.

17. The computing system of claim 15, wherein the computing device comprises a cellular telephone, and the cue is relevant to phone calls.

18. The computing system of claim 15, wherein the computing device comprises location hardware, and the cue is relevant to location of the computing device.

19. The computing system of claim 15, wherein the computing device comprises an email application, and wherein the cue is relevant to information retrieved from the email application.

20. The computing system of claim 15, wherein the computing device is configured to display visual cues.
